(19) United States
(12) Patent Application Publication
(10) Pub. No.: US 2016/0043368 A1
(43) Pub. Date: Feb. 11, 2016

(54) SECONDARY BATTERY AND BATTERY MODULE INCLUDING SECONDARY BATTERY

(71) Applicant: SAMSUNG SDI CO., LTD., Yongin-si (KR)

(72) Inventor: Dukjung Kim, Yongin-si (KR)

(21) Appl. No.: 14/714,057

(22) Filed: May 15, 2015

(30) Foreign Application Priority Data
Aug. 11, 2014 (KR) 10-2014-0103750

(51) Int. Cl. H01M 2/12; H01M 10/42

(52) U.S. Cl. CPC H01M 2/1241; H01M 10/4207; H01M 2200/20

(57) ABSTRACT

In one embodiment, a secondary battery includes: an electrode assembly, a case accommodating the electrode assembly, a cap plate sealing an opening of the case, and an extinguishing member coupled to an exterior side of the case and comprising an extinguishing agent. A battery modules includes: a plurality of secondary batteries each including an electrode assembly, a case accommodating the electrode assembly and a cap plate sealing an opening of the case; and an extinguishing member coupled to exterior sides of the plurality of secondary batteries.

### CROSS-REFERENCE TO RELATED APPLICATION

This application claims priority to and the benefit of Korean Patent Application No. 10-2014-0103750 filed in the Korean intellectual Property Office on Aug. 11, 2014, the entire contents of which are incorporated by reference herein.

### BACKGROUND

1. Field

Aspects of embodiments of the present invention relate to a secondary battery and a battery module including the secondary battery.

2. Description of the Related Art

In general, secondary batteries can be discharged and recharged, unlike primary batteries, which are not designed to be rechargeable. Secondary batteries may be of a low capacity type (or kind), which includes battery cells in the form of a pack used for small portable electronic devices such as cellular phones and camcorders, or a high capacity type (or kind), which includes battery cells used as a motor-driving power source and having several battery cells coupled to (or connected to) one another and widely used as a power source for hybrid vehicles, etc.

Secondary batteries may be manufactured in various suitable shapes, such as a cylindrical shape or prismatic shapes. A secondary battery may be configured such that an electrode assembly, which may be formed by interposing a separator serving as an insulator between positive and negative electrodes, and an electrolyte solution are housed in a case, and a cap plate is installed in the case. Positive and negative electrode terminals are coupled to (or connected to) the electrode assembly and then exposed or protruded to the outside through the cap plate.

### SUMMARY

Aspects of embodiments of the present invention are directed toward a secondary battery and a battery module including the secondary battery that can prevent (or reduce) heating, ignition, and/or explosion by scattering (or dispersing) an extinguishing agent when an internal temperature of the secondary battery rises by installing an extinguishing member outside of the secondary battery.

According to aspects of embodiments of the present invention, a secondary battery includes: an electrode assembly; a case accommodating the electrode assembly; a cap plate sealing an opening of the case; and an extinguishing member coupled to an exterior side of the case and including an extinguishing agent.

The extinguishing member may be at a sidewall of the case.

The extinguishing member may have an opening at one surface in contact with the case.

An extinguishing vent having a relatively small thickness may be at a region corresponding to the extinguishing member.

The opening of the extinguishing member and the extinguishing vent may correspond to each other.

When the internal pressure of the case exceeds a first reference pressure, the extinguishing vent may open to allow the extinguishing agent of the extinguishing member to scatter into an interior of the case.

The cap plate may include a safety vent that opens when the internal pressure of the case exceeds a second reference pressure.

The extinguishing vent may open before the safety vent.

The extinguishing vent may open after the safety vent.

The extinguishing vent and the safety vent may open concurrently (e.g., at the same time).

According to embodiments of the present invention, a battery module includes: a plurality of secondary batteries each including an electrode assembly, a case accommodating the electrode assembly and a cap plate sealing an opening of the case; and an extinguishing member coupled to exterior sides of the plurality of secondary batteries.

The extinguishing member may be at positions corresponding to sidewalls of the plurality of secondary batteries.

The extinguishing member may be coupled to all of the plurality of secondary batteries.

A region of the extinguishing member in contact with the plurality of secondary batteries has a plurality of openings.

An extinguishing vent having a relatively small thickness may be at a region of the case of each of the secondary batteries, the region corresponding to the extinguishing member.

A region of the extinguishing member in contact with the plurality of secondary batteries may have a plurality of openings corresponding to the respective extinguishing vents of the secondary batteries.

When an internal pressure of the case exceeds a reference pressure, the extinguishing vent may open to allow an extinguishing agent of the extinguishing member to scatter into an interior of the case.

As described above, in the secondary battery and the battery module including the secondary battery according to the present invention, heating, ignition, and/or explosion can be prevented (or reduced) by scattering (or dispersing) an extinguishing agent when the internal temperature rises by installing an extinguishing member outside the secondary battery.

In addition, according to the present invention, the secondary battery can be stably shut down, thereby improving stability while preventing (reducing) thermal runaway of the secondary battery.

Additional aspects and/or advantages of the invention will be set forth in part in the description which follows and in part will be apparent from the description or may be learned by practice of the invention.

### BRIEF DESCRIPTION OF THE DRAWINGS

Aspects, features and advantages of the present invention will be more apparent from the following detailed description in conjunction with the accompanying drawings, in which:

FIG. 1 is a perspective view of a secondary battery according to an embodiment of the present invention;

FIG. 2 is a cross-sectional view of the secondary battery shown in FIG. 1;

FIG. 3 is an enlarged view of a portion ‘A’ of FIG. 2;

FIG. 4 is a perspective view of an embodiment of a battery module including a secondary battery according to an embodiment of the present invention; and

FIG. 5 is a side view of the battery module shown in FIG. 4.

### DETAILED DESCRIPTION

Hereinafter, examples of embodiments of the invention will be described in detail with reference to the accompanying drawings such that they can easily be made and used by those skilled in the art.

Advantages and features of the present invention and methods of accomplishing the same may be understood more readily by reference to the following detailed description and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. The present invention will only be defined by the appended claims, and equivalents thereof.

In the drawings, the thickness of layers and regions may be exaggerated for clarity. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the scope of the present invention. Also, in the context of the present application, when a first element is referred to as being “on” a second element, it can be directly on the second element or be indirectly on the second element with one or more intervening elements interposed therebetween. Further, in the context of the present application, when a first element is referred to as being “coupled to” or “connected to” a second element, it can be directly coupled to or connected to the second element or be indirectly coupled to or connected to the second element with one or more intervening elements interposed therebetween.

Hereinafter, a configuration of a secondary battery according to an embodiment of the present invention will be described.

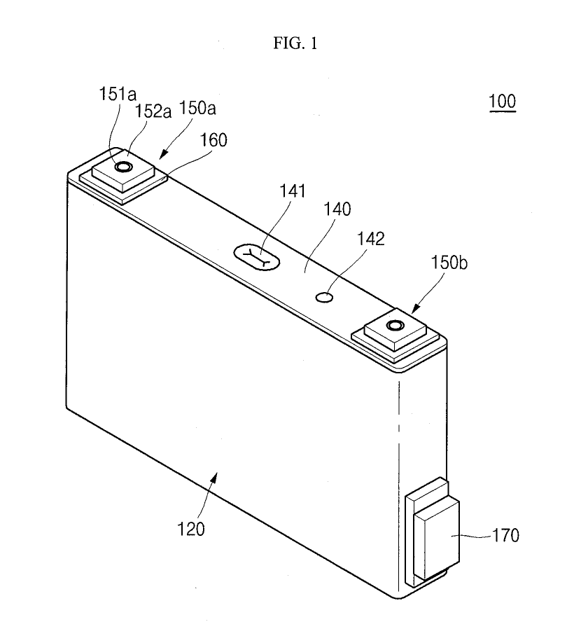

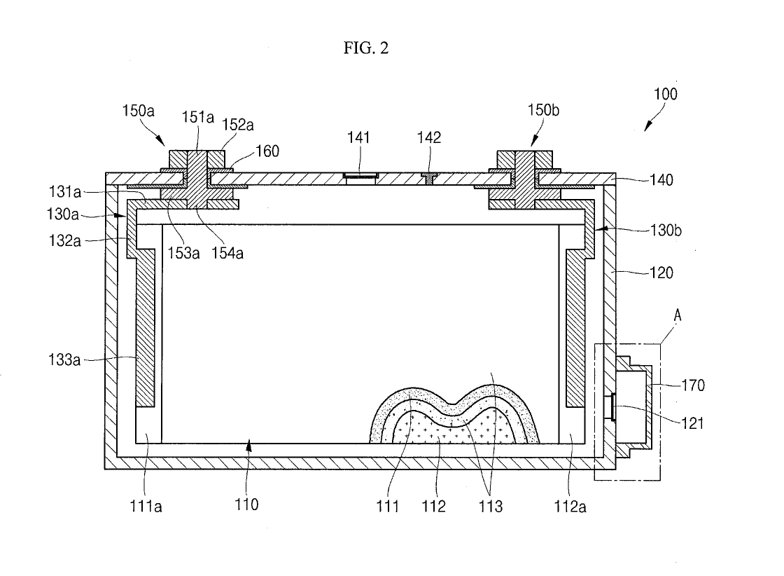

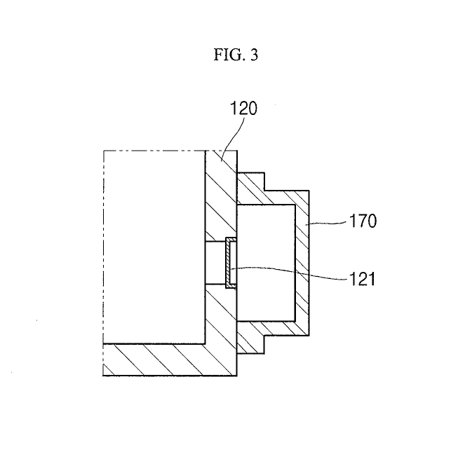

FIG. 1 is a perspective view of a secondary battery according to an embodiment of the present invention, FIG. 2 is a cross-sectional view of the secondary battery shown in FIG. 1, and FIG. 3 is an enlarged view of a portion ‘A’ of FIG. 2.

Referring to FIGS. 1 to 3, the secondary battery 100 includes an electrode assembly 110, a case 120 accommodating the electrode assembly 110, current collectors 130a and 130b electrically coupled to (or connected to) the electrode assembly 110, a cap plate 140 sealing the case 120, electrode terminals 150a and 150b electrically coupled to (or connected to) the current collectors 130a and 130b, respectively, and outwardly protruding while passing through the cap plate 140, and an extinguishing member 170 at (or installed at) one sidewall of the case 120.

In one embodiment, the electrode assembly 110 is formed by winding or laminating a stacked structure having a first electrode plate 111, a separator 113, and a second electrode plate 112, which have a thin plate or a thin foil shape. In this embodiment, the electrode assembly 110 is wound in a substantially jelly roll type (or kind) configuration. Here, the first electrode plate 111 may be a positive electrode and the second electrode plate 112 may be a negative electrode, but the present invention is not limited to this embodiment. In other embodiments, polarities of the first and second electrode plates 111 and 112 may differ from the above description (e.g., the first electrode plate 111 may be a negative electrode and the second electrode plate 112 may be a positive electrode).

The first electrode plate 111 may be formed by applying a first electrode active material, such as, a transition metal oxide, to a first electrode collector including (e.g., formed of) a metal foil including (or made of), for example, aluminum (Al) or an Al alloy. In addition, the first electrode plate 111 may include a first electrode uncoated portion to which the first electrode active material is not applied. The first electrode uncoated portion may function as a passage for current flowing between the first electrode plate 111 and an exterior of the first electrode plate 111. Meanwhile, embodiments of the present invention are not limited to the material of the first electrode plate 111 listed herein.

The second electrode plate 112 may be formed by applying a second electrode active material, such as, graphite or carbon, to a second electrode collector including (e.g., formed of) a metal foil including (e.g., made of), for example, copper (Cu) or nickel (Ni). In addition, the second electrode plate 112 may include a second electrode uncoated portion to which the second electrode active material is not applied. The second electrode uncoated portion may function as a passage for current flowing between the second electrode plate 112 and an exterior of the second electrode plate 112. Meanwhile, embodiments of the present invention are not limited to the material of the second electrode plate 112 listed herein.

The separator 113 may be positioned between the first electrode plate 111 and the second electrode plate 112 to prevent (or reduce) electrical short circuits and to allow movement of lithium ions. The separator 113 according to this embodiment may include (or be made of) a material selected from the group consisting of polyethylene, polypropylene, or a copolymer of polypropylene and polyethylene. Meanwhile, embodiments of the present invention are not limited to the material of the separator 113 listed herein.

The electrode assembly 110 is accommodated in the case 120 with an electrolyte. The electrolyte may include an organic solvent, such as EC (ethylene carbonate), PC (propylene carbonate), DEC (diethyl carbonate), EMC (ethyl methyl carbonate), or DMC (dimethyl carbonate), and a lithium salt, such as LiPF₆, or LiBF₄. In addition, the electrolyte may be in a liquid, solid or gel phase.

The electrode assembly 110 includes coating portions coated with active materials and first and second electrode uncoated portions 111a and 112a that are positioned at opposite ends of the coating portions and that are not coated with active materials. In addition, the current collectors 130a and 130b are coupled to (or connected to) the first and second electrode uncoated portions 111a and 112a, respectively.

The case 120 may have an internal space and may have approximately or substantially a shape of a hexahedron having a top opening. In this embodiment, the case 120 has two long sidewalls, two short sidewalls, a bottom wall and the top opening. In the illustrated embodiment, the case 120 and the cap plate 140 are shown as being assembled with each other, thereby obscuring the opening. However, the opening corresponds to a substantially opened portion at an edge of the cap plate 140.

The case 120 accommodates the electrode assembly 110 with an electrolyte in its internal space. Here, the first and second electrode uncoated portions 111a and 112a of the electrode assembly 110 are positioned to extend a predetermined (or set) length toward the two short sidewalls.

The case 120 may include (or be made of) one or more selected from the group consisting of aluminum, copper, iron, stainless steel (e.g., SUS), ceramic, polymer, and equivalents thereof, but not limited thereto. In addition, the case 120 may be electrically coupled to (or connected to) one of the first electrode plate 111 and the second electrode plate 112 of the electrode assembly 110. For example, the case 120 may have one each of positive and negative polarities.

Meanwhile, the case 120 includes an extinguishing vent 121 having a relatively small thickness at its one sidewall (e.g., the extinguishing vent 121 has a thickness that is relatively smaller or thinner than that of a remaining portion of the one sidewall). For example, the extinguishing vent 121 may be at (or may be formed at) a region corresponding to the extinguishing member 170. The extinguishing vent 121 ruptures when the internal pressure of the case 120 rises, and allows an extinguishing agent of the extinguishing member 170 to scatter (or disperse) into an interior of the case 120, which is described further below. For example, in some embodiments, the extinguishing vent 121 opens when the internal pressure of the case exceeds a reference pressure (e.g., a first reference pressure).

The current collectors 130a and 130b are provided as a pair and include a first current collector 130a and a second current collector 130b. The first and second current collectors 130a and 130b are coupled to (or connected to) the first and second electrode uncoated portions 111a and 112a of the electrode assembly 110, respectively.

The first current collector 130a is electrically coupled (or connected) between the first electrode terminal 150a and the electrode assembly 110 in the case 120. For example, the first current collector 130a includes a first region 131a electrically coupled to (or connected to) the first electrode terminal 150a, and a second region 132a bent from the first region 131a and electrically coupled to (or connected to) the first electrode uncoated portion 111a of the electrode assembly 110. In addition, the second region 132a may have a third region 133a welded to (or formed to be welded to) the first electrode uncoated portion 111a. With this configuration, the electrode assembly 110 is substantially suspended from (or shaped to be substantially suspended from) the first current collector 130a. For example, in that embodiment, the electrode assembly 110 may be in a state in which it is basically downwardly pulled by gravity from the first current collector 130a. Meanwhile, a lower region of the electrode assembly 110 is positioned to be spaced a predetermined (or set) distance apart from the bottom wall of the case 120.

Meanwhile, a coupling hole engaged with a coupling protrusion 154a of the first electrode terminal 150a, which is described further below, may further be at (or be formed in) the first region 131a of the first current collector 130a.

The first current collector 130a may include aluminum, an aluminum alloy, titanium, stainless steel, gold, tantalum, niobium, hafnium, zirconium, vanadium, indium, cobalt, tungsten, tin, beryllium, molybdenum, and/or alloys thereof, but the first current collector is not limited thereto.

The cap plate 140 is on (or formed on) the case 120 and covers the opening of the case 120. The cap plate 140 seals the case 120 to prevent an electrolyte solution contained (or included) in the case 120 from leaking out (or reduce an amount or likelihood of such leaking). Here, a boundary between the case 120 and the cap plate 140 may be welded using laser beams. In addition, the cap plate 140 may include (or be made of) the same or substantially the same material as the case 120.

The cap plate 140 includes a terminal hole to allow the electrode terminals 150a and 150b to upwardly protrude from the cap plate 140. In addition, the cap plate 140 has a safety vent 141 at a roughly central portion of the cap plate (or roughly centrally formed) and having a relatively small thickness (e.g., the safety vent 141 has a thickness that is relatively smaller or thinner than that of a remaining portion of the cap plate). When the internal pressure of the case 120 exceeds a reference pressure (e.g., a second reference pressure) due to gases generated inside the case 120 by over-charge or external shocks, the safety vent 141 is ruptured and opened earlier than (e.g., before) an other part of the cap plate 140 to release the gases, thereby reducing a risk of explosion due to an increase in the internal pressure. The second reference pressure and the first reference pressure may be the same or different (e.g., the first reference pressure may be greater than the second reference pressure, or vice versa). For example, the safety vent 141 may open at a lower pressure than the extinguishing vent 121, or the extinguishing vent 121 may open at a lower pressure than the safety vent 141. In addition, the cap plate 140 may include an injection hole at (or formed at) one region, through which the electrolyte solution is injected, and an injection plug 142 filling the injection hole once the electrolyte solution has been injected.

The first electrode terminal 150a is electrically coupled to (or connected to) the first current collector 130a and outwardly extends a predetermined (or set) length while passing through the cap plate 140. For example, the first electrode terminal 150a is coupled to the first region 131a of the first current collector 130a and outwardly extends a predetermined (or set) length while passing through the cap plate 140 and an insulation member 160. The first electrode terminal 150a is electrically and mechanically coupled to the coupling hole of the first region 131a.

The first electrode terminal 150a includes a pillar-shaped fastening region 151a and a fixing region 152a fixed to the fastening region 151a outside of the case 120 or the cap plate 140 and having a bus bar coupled thereto. Meanwhile, a plate-shaped flange 153a horizontally extending a predetermined (or set) length may further be at (or be formed at) an inside of the case 120 or the cap plate 140 of the fastening region 151a. In addition, a coupling protrusion 154a protruding a predetermined (or set) length along an extension line of the fastening region 151a and coupled to the coupling hole of the first region 131a may further be at (or formed at) a lower portion of the flange 153a.

A top portion of the fastening region 151a is coupled to the fixing region 152a on the cap plate 140 to then be riveted or welded, and the coupling protrusion 154a is coupled to the coupling hole of the first region 131a of the first current collector 130a to then be riveted or welded.

The first electrode terminal 150a may include one or more selected from the group consisting of aluminum, an aluminum alloy and equivalents thereof, but the first electrode terminal is not limited thereto.

Meanwhile, configurations of the second current collector 130b and the second electrode terminal 150b are substantially the same as those of the first current collector 130a and the first electrode terminal 150a, respectively, and, therefore, detailed descriptions thereof will not be repeated here.

The insulation member 160 is between (or formed between) each of the electrode terminals 150a and 150b and the cap plate 140. For example, the insulation member 160 is interposed between the fastening region 151a and the cap plate 140, between the fixing region 152a and the cap plate 140, and between the flange 153a and the cap plate 140. The insulation member 160 electrically insulates each of the electrode terminals 150a and 150b and the cap plate 140 from each other. The insulation member 160 may include one or more selected from the group consisting of polyphenylene sulfide (PPS), perfluoroalkoxy (PFA) and equivalents thereof, but the insulation member is not limited thereto.

In some cases, the insulation member 160 may be configured to insulate only one of the electrode terminals 150a and 150b from the cap plate 140. For example, in some embodiments, the insulation member 160 is not on (or formed on) an edge of the first electrode terminal 150a, so that the first electrode terminal 150a and the cap plate 140 are brought into direct contact (or electrical contact) with each other. Here, in this embodiment, the cap plate 140 or the case 120 may have the same polarity as the first electrode terminal 150a.

The extinguishing member 170 includes an accommodation space for accommodating the extinguishing agent and is outside (or installed outside) the case 120. For example, the extinguishing member 170 may be at (or on or formed on) one selected from long sidewalls or short sidewalls of the case 120. The extinguishing member 170 is configured to have an opening (or open region) such that a surface of the extinguishing member 170 in contact with a sidewall of the case 120 is opened (e.g., is open to the case 120).

Meanwhile, the extinguishing vent 121 having a relatively small thickness is at (or on or formed on) the sidewall of the case 120 corresponding to the extinguishing member 170. Since the extinguishing vent 121 corresponds to the opening (or open region) of the extinguishing member 170, the extinguishing agent of the extinguishing member 170 may be injected into the case 120. For example, as the extinguishing vent 121 is ruptured due to the internal pressure of the case 120, the extinguishing agent of the extinguishing member 170 can be scattered (or dispersed) into the case 120.

Functions of the extinguishing vent 121 and the extinguishing member 170 will now be described further. When an internal short-circuit or an external short-circuit due to penetration occurs to the secondary battery 100, the internal temperature of the case 120 may increase. The increased temperature evaporates the electrolyte solution contained (or included) in the case 120 and the internal pressure of the case 120 increases. Therefore, a pressure difference between the inside of the case 120 and the inside of the extinguishing member 170 is generated, and the extinguishing vent 121 is ruptured and opened due to the pressure difference, thereby allowing the extinguishing agent contained (or included) in the extinguishing member 170 to be scattered (or dispersed) into the case 120.

The extinguishing agent is capable of removing one or more of three firing elements. For example, the extinguishing agent may perform functions of shielding oxygen and cooling. Therefore, even when a short-circuit occurs to the secondary battery 100, heating, ignition and/or explosion may be avoided (or an amount or likelihood of heating, ignition and/or explosion may be reduced) by the extinguishing agent scattered (or dispersed) into the case 120.

Usable or suitable examples of the extinguishing agent may include two or more kinds of mixtures including one or more of alkali, acid, a carbon compound, a nitrogen compound, water or a surfactant. For example, an extinguishing agent containing (or including) potassium bicarbonate as a main component, an extinguishing agent containing (or including) sodium bicarbonate as a main component, an extinguishing agent containing (or including) a reaction product of potassium bicarbonate and urea as a main component, and an extinguishing agent containing (or including) ammonium phosphate as a main component, may be used as the extinguishing agent. For example, an ammonia-series oxygen-dilution extinguishing agent may be used, but the extinguishing agent is not limited thereto. In addition, the extinguishing agent may be in any of a solid phase, a liquid phase, and a gas phase.

Meanwhile, the extinguishing vent 121 may be configured to be opened earlier than (e.g., before) the safety vent 141. In this case, heating, ignition and explosion of the secondary battery 100 are primarily suppressed (or reduced) by the extinguishing agent scattered (or dispersed) into the case 120. Then, even if the temperature and/or internal pressure of the case 120 further increase, the safety vent 141 opens to release gases, thereby secondarily preventing (or reducing) heating, ignition and/or explosion of the secondary battery 100. Here, the extinguishing vent 121 may be opened later than (e.g., after) the safety vent 141. In this case, the safety vent 141 is primarily opened by the increases in the temperature and/or internal pressure of the case 120, and even if the temperature and/or internal pressure of the case 120 are further increased, the extinguishing vent 121 is opened to secondarily prevent (or reduce) heating, ignition and/or explosion of the secondary battery 100. In addition, the extinguishing vent 121 may be opened concurrently (e.g., almost at the same time or simultaneously) with the safety vent 141. In this case, since the extinguishing vent 121 and the safety vent 141 are concurrently or simultaneously opened, the heating, ignition and/or explosion of the secondary battery 100 can be prevented (or reduced) in a secure manner.

As described above, in the secondary battery 100 according to the present embodiment of the present invention, the extinguishing member 170 containing (or including) an extinguishing agent is at (or on or installed on) an outer wall of the case 120, thereby preventing (or reducing) heating, ignition and/or explosion of the secondary battery 100 when a short-circuit occurs to the secondary battery 100 due to an external shock.

For example, when a short-circuit occurs to the secondary battery 100, the extinguishing vent 121 opens due to the increases in the temperature and/or internal pressure of the case 120 and the extinguishing agent of the extinguishing member 170 is scattered (or dispersed) into the case 120. Heating and/or ignition of the secondary battery 100 can be prevented (or reduced) by the extinguishing agent capable of shielding oxygen and cooling. In addition, thermal runaway of the secondary battery 100 can be prevented (or reduced) and stability of the secondary battery 100 can be improved by constructing a condition for stable shut-down of the electrode assembly 110 (e.g., by way of the electrode assembly 110 having a shut-down characteristic).

In addition, the secondary battery 100 includes not only the extinguishing vent 121 corresponding to the extinguishing member 170 but also the safety vent 141, thereby secondarily preventing (or reducing) ignition and/or explosion of the secondary battery 100 and ultimately further improving the stability of the secondary battery 100.

Hereinafter, a configuration of a battery module including a secondary battery according to an embodiment of the present invention will be described.

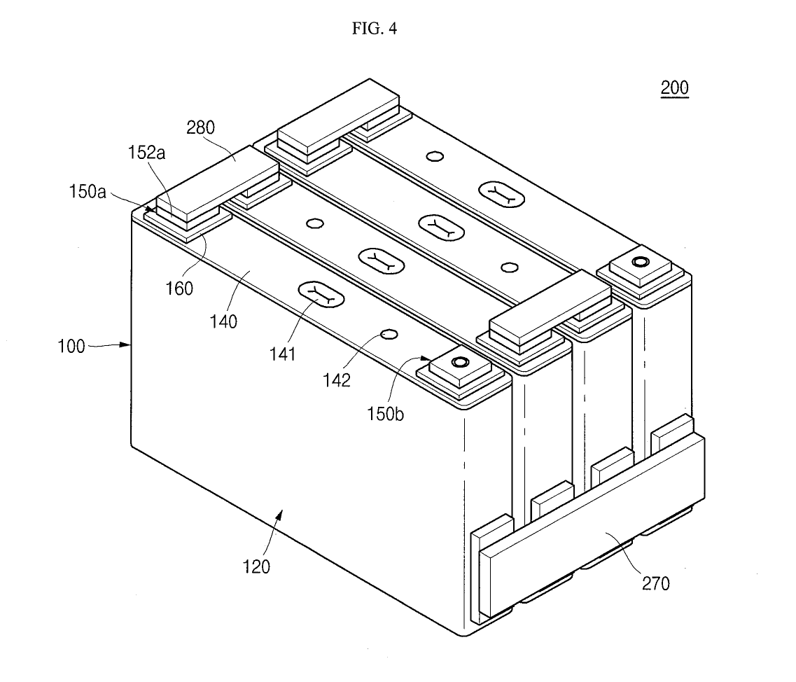

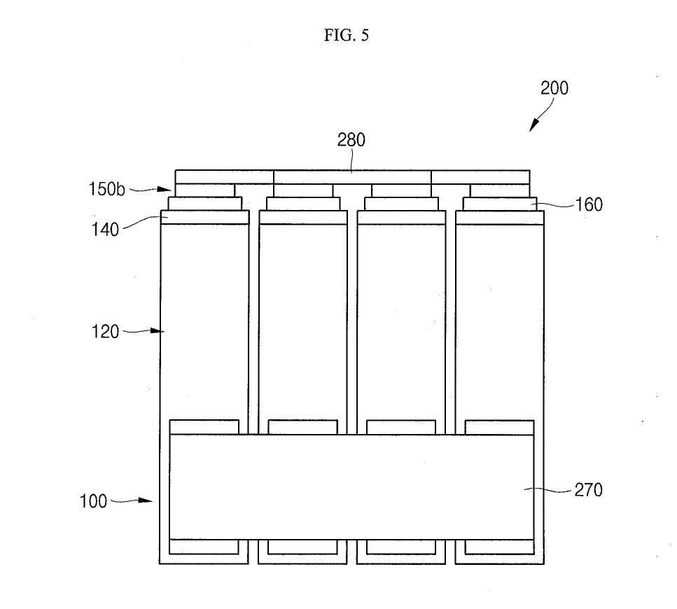

FIG. 4 is a perspective view of a battery module including a secondary battery according to an embodiment of the present invention and FIG. 5 is a side view of the battery module shown in FIG. 4. The same components and functions as those of the secondary battery according to the previous embodiment are denoted by the same reference numerals. The following description will focus on differences between the secondary batteries according to the present and previous embodiments described above.

Referring to FIGS. 4 and 5, a battery module 200 including ₜhe secondary battery according to an embodiment of the present invention includes a plurality of secondary batteries 100, an extinguishing member 270 outside (or installed outside) of the secondary batteries 100, and a plurality of bus bars 280 electrically coupling (or connecting) the plurality of secondary batteries 100 to each other. In the embodiment of the secondary battery 100 described above, the extinguishing member 170 corresponds to (or is formed to correspond to) one secondary battery 100. However, the extinguishing member 270 may correspond to (or be formed to correspond to) the plurality of secondary batteries 100, as described below with respect to the battery module 200.

The secondary batteries 100 include a plurality of secondary batteries, which are aligned in a horizontal direction, but the secondary batteries are not limited thereto. Each of the secondary batteries 100 includes a case 120, a cap plate 140 covering the case 120, and first and second electrode terminals 150a and 150b upwardly protruding through the cap plate 140. The configurations of the secondary batteries 100 are the same as described above, and the descriptions thereof will not be repeated here.

The extinguishing member 270 includes an accommodation space for accommodating an extinguishing agent and is outside (or installed outside) of the battery module 200. For example, the extinguishing member 270 is in contact with (or is formed to be brought into contact with) a short sidewall of the case 120 of each of the secondary batteries 100 in the battery module 200. Here, the extinguishing member 270 may have (or be formed to have) a length substantially equal to a sum of widths (or widthwise lengths) of the short sidewalls of the plurality of secondary batteries 100 aligned in the horizontal direction. In addition, the extinguishing member 270 is configured such that it includes a region in contact with the short sidewall of a case 120 that is opened (e.g., is open to the case 120). For example, the extinguishing member 270 may include a plurality of openings (or open regions) corresponding to the secondary batteries 100, respectively.

Meanwhile, an extinguishing vent having a relatively small thickness is at (or on or formed on) a short sidewall of the case 120 corresponding to the extinguishing member 270 (e.g., the extinguishing vent has a thickness that is relatively smaller or thinner than that of a remaining portion of the short sidewall). Since the extinguishing vent corresponds to the respective opening (or open region) of the extinguishing member 270, the extinguishing agent of the extinguishing member 270 may be injected into the case 120. For example, as the extinguishing vent is ruptured by the internal pressure of the case 120, the extinguishing agent of the extinguishing member 270 can be scattered (or dispersed) into the case 120.

As described above, the extinguishing member 270 may be coupled to (or connected to) all of the respective secondary batteries 100 of the battery module 200 to then correspond thereto individually, but the extinguishing member is not limited thereto. For example, even when a short-circuit occurs to a particular one of the secondary batteries 100 of the battery module 200, the extinguishing vent of the corresponding one of the secondary batteries 100 is ruptured, thereby allowing the extinguishing agent to be supplied to the inside of the secondary battery 100. Since the extinguishing member 270 can individually correspond to each of the secondary batteries 100 of the battery module 200, the reliability and stability of the battery module 200 can be further improved.

The bus bars 280 electrically couple (or connect) the plurality of secondary batteries 100 to each other in series. For example, the bus bars 280 electrically couple (or connect) a first electrode terminal 150a (or a second electrode terminal 150b) of one of the secondary batteries 100 and a second electrode terminal 150b (or a first electrode terminal 150a) of an other of the secondary batteries 100 to each other. Here, the plurality of bus bars 280 may electrically couple (or connect) the plurality of secondary batteries 100 to each other in parallel.

In such a manner, the battery module 200 including ₜhe secondary batteries 100 according to the present embodiment of the present invention includes the extinguishing member 270 containing (or including) the extinguishing agent outside (or installed outside) of the battery module 200, that is, at a short sidewall of the case 120 of each of the plurality of secondary batteries 100 of the battery module 200, thereby preventing (or reducing) heating, ignition and/or explosion of the battery module 200.

For example, when a short-circuit occurs to a particular one of the secondary batteries 100 of the battery module 200, the extinguishing vent corresponding to that one of the secondary batteries 100 is opened due to the increases in the temperature and/or internal pressure of the case 120 and the extinguishing agent of the extinguishing member 170 is scattered (or dispersed) into the case 120. Heating and/or ignition of the secondary batteries 100 can be prevented (or reduced) by the extinguishing agent capable of shielding oxygen and cooling. In addition, thermal runaway of the secondary batteries 100 can be prevented (or reduced) and the stability of the secondary batteries 100 can be improved by constructing a condition for stable shut-down of the electrode assembly 110 (e.g., by way of the electrode assembly 110 having a shut-down characteristic).

In some embodiments, since the extinguishing member 270 individually corresponds to each of the plurality of secondary batteries 100 of the battery module 200, the extinguishing agent can be accurately or independently supplied to one among the secondary batteries 100 (i.e., the one having the short-circuit having occurred thereto), and the reliability and stability of the battery module 200 can be further improved.

Although a secondary battery and a battery module including the secondary battery according to the present invention have been described with reference to certain exemplary embodiments thereof, it will be understood by those skilled in the art that the invention is not limited to the disclosed embodiments, but, on the contrary, a variety of modifications and variations may be made to the present invention without departing from the spirit or scope of the present invention defined in the appended claims, and their equivalents.

What is claimed is:

1. A secondary battery comprising:
an electrode assembly;
a case accommodating the electrode assembly;
a cap plate sealing an opening of the case; and
an extinguishing member coupled to an exterior side of the case and comprising an extinguishing agent.

2. The secondary battery of claim 1, wherein the extinguishing member is at a sidewall of the case.

3. The secondary battery of claim 1, wherein the extinguishing member has an opening at one surface in contact with the case.

4. The secondary battery of claim 1, wherein an extinguishing vent having a relatively small thickness is at a region corresponding to the extinguishing member.

5. The secondary battery of claim 4, wherein the extinguishing member has an opening at one surface in contact with the case, and the opening of the extinguishing member and the extinguishing vent correspond to each other.

6. The secondary battery of claim 4, wherein when an internal pressure of the case exceeds a first reference pressure, the extinguishing vent opens to allow the extinguishing agent of the extinguishing member to scatter into an interior of the case.

7. The secondary battery of claim 4, wherein the cap plate comprises a safety vent that opens when an internal pressure of the case exceeds a second reference pressure.

8. The secondary battery of claim 7, wherein the extinguishing vent opens before the safety vent.

9. The secondary battery of claim 7, wherein the extinguishing vent opens after the safety vent.

10. The secondary battery of claim 7, wherein the extinguishing vent and the safety vent open concurrently.

11. A battery module comprising:
a plurality of secondary batteries each comprising an electrode assembly, a case accommodating the electrode assembly and a cap plate sealing an opening of the case; and
an extinguishing member coupled to exterior sides of the plurality of secondary batteries.

12. The battery module of claim 11, wherein the extinguishing member is at positions corresponding to sidewalls of the plurality of secondary batteries.

13. The battery module of claim 11, wherein the extinguishing member is coupled to all of the plurality of secondary batteries.

14. The battery module of claim 11, wherein a region of the extinguishing member in contact with the plurality of secondary batteries has a plurality of openings.

15. The battery module of claim 11, wherein an extinguishing vent having a relatively small thickness is at a region of the case of each of the secondary batteries, the region corresponding to the extinguishing member.

16. The battery module of claim 15, wherein a region of the extinguishing member in contact with the plurality of secondary batteries has a plurality of openings corresponding to the respective extinguishing vents of the secondary batteries.

17. The battery module of claim 15, wherein when an internal pressure of the case exceeds a reference pressure, the extinguishing vent opens to allow an extinguishing agent of the extinguishing member to scatter into an interior of the case.
